(19) United States
(12) Patent Application Publication
(10) Pub. No.: US 2025/0036251 A1
(43) Pub. Date: Jan. 30, 2025

(54) SYSTEM AND METHOD FOR REDUCING INADVERTENT CHANGES IN DRAG-AND-DROP GRAPHICAL USER INTERFACE BUILDERS OR OTHER APPLICATIONS

(71) Applicant: 3forge LLC, New York, NY (US)

(72) Inventor: Robert H. Cooke, Celebration, FL (US)

(21) Appl. No.: 18/781,557

(22) Filed: Jul. 23, 2024

Related U.S. Application Data
(60) Provisional application No. 63/516,333, filed on Jul. 28, 2023.

(51) Int. Cl. G06F 3/0481; G06F 3/04842; G06F 3/0486; G06F 8/34; G06F 8/38

(52) U.S. Cl. CPC G06F 3/0481; G06F 3/04842; G06F 8/34; G06F 8/38; G06F 3/0486

(57) ABSTRACT

A method includes displaying an interface containing at least one graphical user interface (GUI) component of a graphical user interface. The method also includes receiving input associated with a change to the at least one GUI component or to the graphical user interface. The method further includes displaying a selectable change indicator element in the interface, where the selectable change indicator element indicates that the change to the at least one GUI component or to the graphical user interface has been made. The method also includes detecting a selection of the selectable change indicator element. In addition, the method includes applying or saving the change to the at least one GUI component or to the graphical user interface in response to the selection of the selectable change indicator element.

### CROSS-REFERENCE TO RELATED APPLICATION AND PRIORITY CLAIM

This application claims priority under 35 U.S.C. § 119 (e) to U.S. Provisional Patent Application No. 63/516,333 filed on Jul. 28, 2023. This provisional application is hereby incorporated by reference in its entirety.

### TECHNICAL FIELD

This disclosure is generally directed to graphical user interfaces. More specifically, this disclosure is directed to a system and method for reducing inadvertent changes in drag-and-drop graphical user interface builders or other applications.

### BACKGROUND

Numerous devices and systems use graphical user interfaces (GUIs) to enable users to navigate and view various information or other content. For example, cloud-based applications and other applications often support the use of dashboards, webpages, or other graphical user interfaces that can be navigated by users. A graphical user interface supporting “non-mutating navigation” may often be needed or desired in various circumstances. Non-mutating navigation refers to navigation mechanisms that should not change even when contents of a graphical user interface are updated. For instance, dashboards or other graphical user interfaces may contain many panels, widgets, visualizations, pages, tabs, windows, or other components, and certain navigations between certain components may need to be maintained even when the graphical user interfaces are being updated.

### SUMMARY

This disclosure is directed to a system and method for reducing inadvertent changes in drag-and-drop graphical user interface builders or other applications.

In a first embodiment, a method includes displaying an interface containing at least one graphical user interface (GUI) component of a graphical user interface. The method also includes receiving input associated with a change to the at least one GUI component or to the graphical user interface. The method further includes displaying a selectable change indicator element in the interface, where the selectable change indicator element indicates that the change to the at least one GUI component or to the graphical user interface has been made. The method also includes detecting a selection of the selectable change indicator element. In addition, the method includes applying or saving the change to the at least one GUI component or to the graphical user interface in response to the selection of the selectable change indicator element.

In a second embodiment, an apparatus includes at least one processing device configured to initiate display of an interface containing at least one GUI component of a graphical user interface. The at least one processing device is also configured to receive input associated with a change to the at least one GUI component or to the graphical user interface. The at least one processing device is further configured to initiate display of a selectable change indicator element in the interface, where the selectable change indicator element indicates that the change to the at least one GUI component or to the graphical user interface has been made. The at least one processing device is also configured to detect a selection of the selectable change indicator element. In addition, the at least one processing device is configured to apply or save the change to the at least one GUI component or to the graphical user interface in response to the selection of the selectable change indicator element.

In a third embodiment, a non-transitory machine readable medium contains instructions that when executed cause at least one processor to initiate display of an interface containing at least one GUI component of a graphical user interface. The non-transitory machine readable medium also contains instructions that when executed cause the at least one processor to receive input associated with a change to the at least one GUI component or to the graphical user interface. The non-transitory machine readable medium further contains instructions that when executed cause the at least one processor to initiate display of a selectable change indicator element in the interface, where the selectable change indicator element indicates that the change to the at least one GUI component or to the graphical user interface has been made. The non-transitory machine readable medium also contains instructions that when executed cause the at least one processor to detect a selection of the selectable change indicator element. In addition, the non-transitory machine readable medium contains instructions that when executed cause the at least one processor to apply or save the change to the at least one GUI component or to the graphical user interface in response to the selection of the selectable change indicator element.

Any single one or any combination of the following features may be used with the first, second, or third embodiment. The change to the at least one GUI component or to the graphical user interface may be applied or saved only in response to the selection of the selectable change indicator element. The selectable change indicator element may be associated with a function handler, and the function handler may apply or save the change to the at least one GUI component or to the graphical user interface in response to the selection of the selectable change indicator element. Each GUI component or the graphical user interface may be associated with metadata, and the metadata associated with the at least one GUI component or the graphical user interface may be updated when applying or saving the change to the at least one GUI component or to the graphical user interface. The interface may be configured to present multiple GUI components of the graphical user interface, the selectable change indicator element may include one of multiple selectable change indicator elements, and different selectable change indicator elements may be associated with different GUI components. The interface may be configured to present multiple GUI components of the graphical user interface, at least two of the multiple GUI components may form a nested GUI component, the selectable change indicator element may include one of multiple selectable change indicator elements, and at least two of the selectable change indicator elements may be associated with the at least two GUI components forming the nested GUI component. The interface may be configured to present multiple GUI components of the graphical user interface, and multiple changes to the multiple GUI components may be applied or saved in response to the selection of the selectable change indicator element.

Other technical features may be readily apparent to one skilled in the art from the following figures, descriptions, and claims.

### BRIEF DESCRIPTION OF THE DRAWINGS

For a more complete understanding of this disclosure and its features, reference is now made to the following description, taken in conjunction with the accompanying drawings, in which:

FIG. 1 illustrates an example system for reducing inadvertent changes in a drag-and-drop graphical user interface builder or other application according to this disclosure;

FIG. 2 illustrates an example device for reducing inadvertent changes in a drag-and-drop graphical user interface builder or other application according to this disclosure;

FIGS. 3 through 6 illustrate an example interface for a drag-and-drop graphical user interface builder or other application supporting a mechanism for reducing inadvertent changes according to this disclosure; and

FIG. 7 illustrates an example method for reducing inadvertent changes in a drag-and-drop graphical user interface builder or other application according to this disclosure.

### DETAILED DESCRIPTION

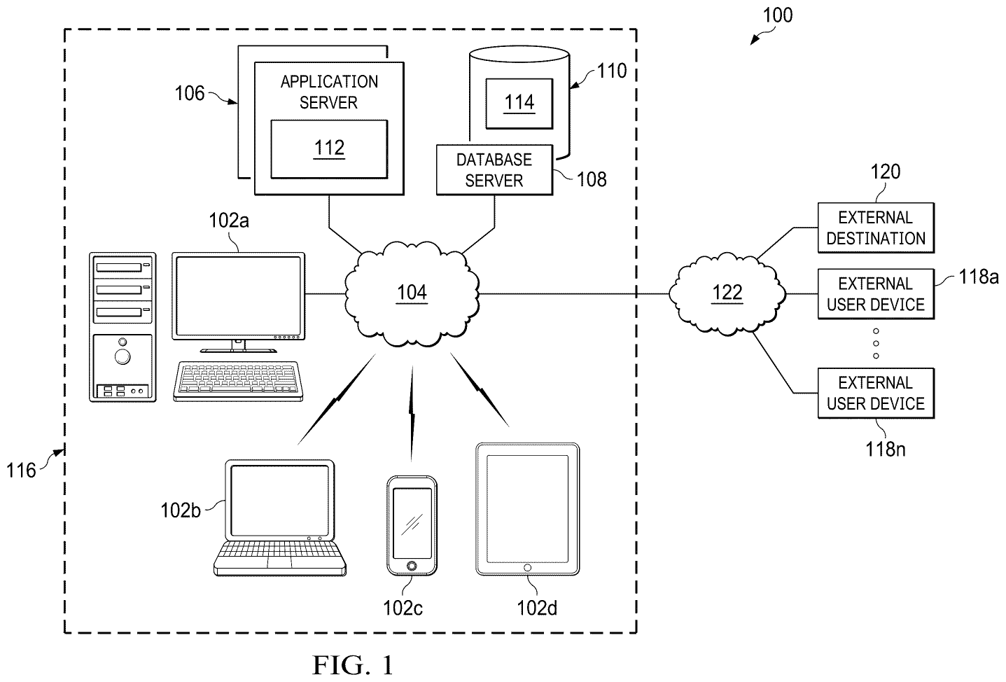

FIGS. 1 through 7, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

As noted above, numerous devices and systems use graphical user interfaces (GUIs) to enable users to navigate and view various information or other content. For example, cloud-based applications and other applications often support the use of dashboards, webpages, or other graphical user interfaces that can be navigated by users. A graphical user interface supporting “non-mutating navigation” may often be needed or desired in various circumstances. Non-mutating navigation refers to navigation mechanisms that should not change even when contents of a graphical user interface are updated. For instance, dashboards or other graphical user interfaces may contain many panels, widgets, visualizations, pages, tabs, windows, or other components, and certain navigations between certain components may need to be maintained even when the graphical user interfaces are being updated.

Non-mutating navigation may be needed or desired in order to ensure that dashboards and other graphical user interfaces continue to function properly after changes are made to the graphical user interfaces. Unfortunately, graphical user interface builders save changes to graphical user interfaces immediately, and those saved changes are applied permanently to the graphical user interfaces. As a result, it is possible for changes to a graphical user interface to be inadvertently saved and applied, which cause undesired modifications to the graphical user interface. For example, inadvertent actions (like focusing on a tab) or executing custom scripts can cause permanent changes to dashboards or other graphical user interfaces. This makes it difficult to track the real substantive changes to the graphical user interfaces over time. Also, once changes are made, the only option is for a designer or other user to manually and meticulously make additional changes that reverse the undesired modifications to the graphical user interface. This can be disruptive and cause other problems in a number of circumstances.

This disclosure provides various techniques for reducing inadvertent changes in drag-and-drop graphical user interface builders or other applications. As described in more detail below, a drag-and-drop graphical user interface builder or other application allows a user to define a graphical user interface, such as by dragging and dropping or otherwise manipulating GUI components of a graphical user interface within an interface of the builder or other application. Metadata can be associated with individual GUI components and/or the graphical user interface as a whole. The metadata may identify any suitable characteristics related to individual GUI components and/or the graphical user interface, such as x position, y position, z index, order, and/or color of individual GUI components.

When a change is made to an individual GUI component or to the graphical user interface, a selectable change indicator element is displayed in association with the individual GUI component or otherwise in association with the graphical user interface. The change is not applied until the selectable change indicator element is actually selected by a user, at which point updated metadata associated with the change to the individual GUI component or the graphical user interface is applied or saved (such as by using a function handler associated with the selectable change indicator element). For example, if the user moves the individual GUI component within the graphical user interface, a selectable change indicator element may be displayed to the user. Metadata for the individual GUI component (such as metadata identifying its position within the graphical user interface) is not updated until the user clicks on or otherwise selects the selectable change indicator element. Once the selectable change indicator element is selected, the function handler associated with the selectable change indicator element can apply and save updated metadata (such as the new position of the individual GUI component within the graphical user interface). This can be repeated across any number of individual GUI components, groups of individual GUI components, and/or the graphical user interface.

In this way, at least one selectable change indicator element in a graphical user interface builder or other application can be used to control when updated metadata is applied or saved for a graphical user interface. This helps to ensure that metadata is not updated until a selectable change indicator element is actually selected by a user, which can help to reduce or minimize inadvertent changes to the graphical user interface. If not desired, the change can be rejected, and the graphical user interface can remain in its prior state since no metadata was updated for the graphical user interface. Among other things, this can help to ensure that non-mutating navigation is maintained within the graphical user interface and is not changed unless desired, although the described techniques may be used for other purposes. Also, the selection of each selectable change indicator element can be used to control whether metadata for individual GUI components can be applied or saved, and multiple selectable change indicator elements (possibly of different types or combinations) may be used to provide the desired granularity and control over metadata related to the graphical user interface. For instance, the selectable change indicator elements may be used with nested GUI components in which some GUI components contain other nested components. As particular examples, this may be useful with GUI components like dividers, tabs, grids, or other “container” type GUI components. Multiple selectable change indicator elements can also be used with a single GUI component to control different aspects of the associated metadata, which may be useful to give more control over a GUI component's metadata. In addition, a single selectable change indicator element may be used to control one or more GUI component targets and apply/save the associated metadata.

Note that the described functionality here may be used when creating or modifying any suitable graphical user interfaces. Example use cases here may include creating or modifying graphical user interfaces for web-based applications, desktop applications, cloud-based applications, and “heavy-weight” desktop applications. Moreover, the applications may be used in any suitable industries or other environments, such as manufacturing, sales, finance, home, or office environments. In addition, note that updating or saving metadata is often described as being performed in response to selection of a selectable change indicator element. However, one or more other or additional actions may occur in response to selection of a selectable change indicator element in order to apply or save one or more changes to one or more GUI components or to the overall graphical user interface.

FIG. 1 illustrates an example system 100 for reducing inadvertent changes in a drag-and-drop graphical user interface builder or other application according to this disclosure. As shown in FIG. 1, the system 100 includes multiple user devices 102a-102d, at least one network 104, at least one application server 106, and at least one database server 108 associated with at least one database 110. Note, however, that other combinations and arrangements of components may also be used here.

In this example, each user device 102a-102d is coupled to or communicates over the network(s) 104. Communications between each user device 102a-102d and at least one network 104 may occur in any suitable manner, such as via a wired or wireless connection. Each user device 102a-102d represents any suitable device or system used by at least one user to provide information to the application server 106 or database server 108 or to receive information from the application server 106 or database server 108. Any suitable number(s) and type(s) of user devices 102a-102d may be used in the system 100. In this particular example, the user device 102a represents a desktop computer, the user device 102b represents a laptop computer, the user device 102c represents a smartphone, and the user device 102d represents a tablet computer. However, any other or additional types of user devices may be used in the system 100. Each user device 102a-102d includes any suitable structure configured to transmit and/or receive information.

The at least one network 104 facilitates communication between various components of the system 100. For example, the network(s) 104 may communicate Internet Protocol (IP) packets, frame relay frames, Asynchronous Transfer Mode (ATM) cells, or other suitable information between network addresses. The network(s) 104 may include one or more local area networks (LANs), metropolitan area networks (MANs), wide area networks (WANs), all or a portion of a global network such as the Internet, or any other communication system or systems at one or more locations. The network(s) 104 may also operate according to any appropriate communication protocol or protocols.

The at least one application server 106 is coupled to the at least one network 104 and is coupled to or otherwise communicates with the database server 108. The database server 108 operates to store and facilitate retrieval of various information used, generated, or collected by the application server 106 and the user devices 102a-102d in the database 110. While the database server 108 and database 110 are shown here as being separate from the application server 106, the application server 106 may itself incorporate the database server 108 and the database 110.

The application server 106 supports various functions related to the creation, deployment, and use of graphical user interfaces, and the database server 108 and database 110 are used to store information related to the graphical user interfaces. For example, the application server 106 may be used to execute at least one application 112, such as a graphical user interface builder, which allows users to create and modify graphical user interfaces. As a particular example, the at least one application 112 may allow users of the user devices 102a-102d to drag-and-drop GUI components and define various properties of the GUI components. Metadata 114 associated with the individual GUI components and/or the overall graphical user interfaces can be stored in the database 110. In various cases, the at least one application 112 can retrieve the metadata 114 from the database 110, allow users to modify graphical user interfaces defined by the metadata 114 as needed or desired, and write updated metadata for the modified graphical user interfaces back to the database 110.

As described below, the at least one application 112 can support the use of a mechanism that reduces or prevents a change from being made to a graphical user interface unless and until a user selects a selectable change indicator element (such as a “pin” or other graphical element) presented by the at least one application 112. This can help to reduce or prevent a user from making an inadvertent change to a graphical user interface, such as a change that might interrupt non-mutating navigation within the graphical user interface.

In some cases, a graphical user interface created by the at least one application 112 may be used internally by a company or other organization 116. For instance, a graphical user interface may relate to an internal application or other internal function within the organization 116. In other cases, a graphical user interface created by the at least one application 112 may be provided to external user devices 118a-118n for use. The graphical user interface may also or alternatively be deployed, such as to at least one external destination 120 (like a remote server or a cloud-based system), for use. At least one additional network 122 may be used to facilitate communications with the external user devices 118a-118n or the at least one external destination 120.

Although FIG. 1 illustrates one example of a system 100 for reducing inadvertent changes in a drag-and-drop graphical user interface builder or other application, various changes may be made to FIG. 1. For example, the system 100 may include any number of user devices 102a-102d, networks 104, 122, application servers 106, database servers 108, databases 110, applications 112, metadata 114, organizations 116, external user devices 118a-118n, and external destinations 120. Also, these components may be located in any suitable locations and might be distributed over a large area. In addition, while FIG. 1 illustrates one example operational environment in which mechanisms can be used for reducing inadvertent changes in a drag-and-drop graphical user interface builder or other application, this functionality may be used in any other suitable systems.

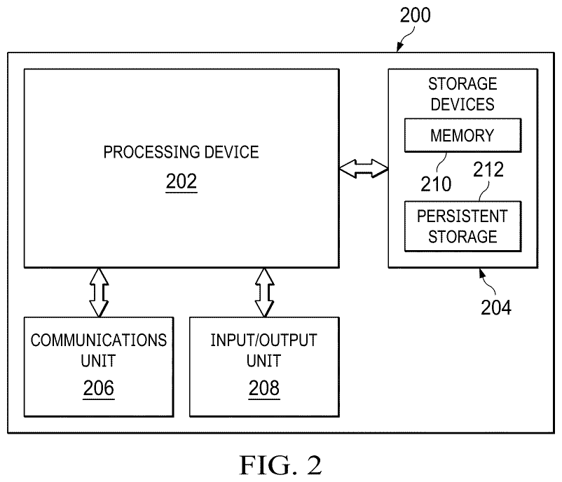

FIG. 2 illustrates an example device 200 for reducing inadvertent changes in a drag-and-drop graphical user interface builder or other application according to this disclosure. One or more instances of the device 200 may, for example, be used to at least partially implement the functionality of each application server 106 in FIG. 1. However, the functionality of each application server 106 may be implemented in any other suitable manner. Also, the same or similar structure may be used to at least partially implement the functionality of each user device 102a-102d and database server 108 in FIG. 1.

As shown in FIG. 2, the device 200 denotes a computing device or system that includes at least one processing device 202, at least one storage device 204, at least one communications unit 206, and at least one input/output (I/O) unit 208. The processing device 202 may execute instructions that can be loaded into a memory 210. The processing device 202 includes any suitable number(s) and type(s) of processors or other processing devices in any suitable arrangement. Example types of processing devices 202 include one or more microprocessors, microcontrollers, digital signal processors (DSPs), application specific integrated circuits (ASICs), field programmable gate arrays (FPGAs), or discrete circuitry.

The memory 210 and a persistent storage 212 are examples of storage devices 204, which represent any structure(s) capable of storing and facilitating retrieval of information (such as data, program code, and/or other suitable information on a temporary or permanent basis). The memory 210 may represent a random access memory or any other suitable volatile or non-volatile storage device(s). The persistent storage 212 may contain one or more components or devices supporting longer-term storage of data, such as a read only memory, hard drive, Flash memory, or optical disc.

The communications unit 206 supports communications with other systems or devices. For example, the communications unit 206 can include a network interface card or a wireless transceiver facilitating communications over a wired or wireless network, such as the network 104. The communications unit 206 may support communications through any suitable physical or wireless communication link(s).

The I/O unit 208 allows for input and output of data. For example, the I/O unit 208 may provide a connection for user input through a keyboard, mouse, keypad, touchscreen, or other suitable input device. The I/O unit 208 may also send output to a display, printer, or other suitable output device. Note, however, that the I/O unit 208 may be omitted if the device 200 does not require local I/O, such as when the device 200 represents a server or other device that can be accessed remotely.

Although FIG. 2 illustrates one example of a device 200 for reducing inadvertent changes in a drag-and-drop graphical user interface builder or other application, various changes may be made to FIG. 2. For example, computing and communication devices and systems come in a wide variety of configurations, and FIG. 2 does not limit this disclosure to any particular computing or communication device or system.

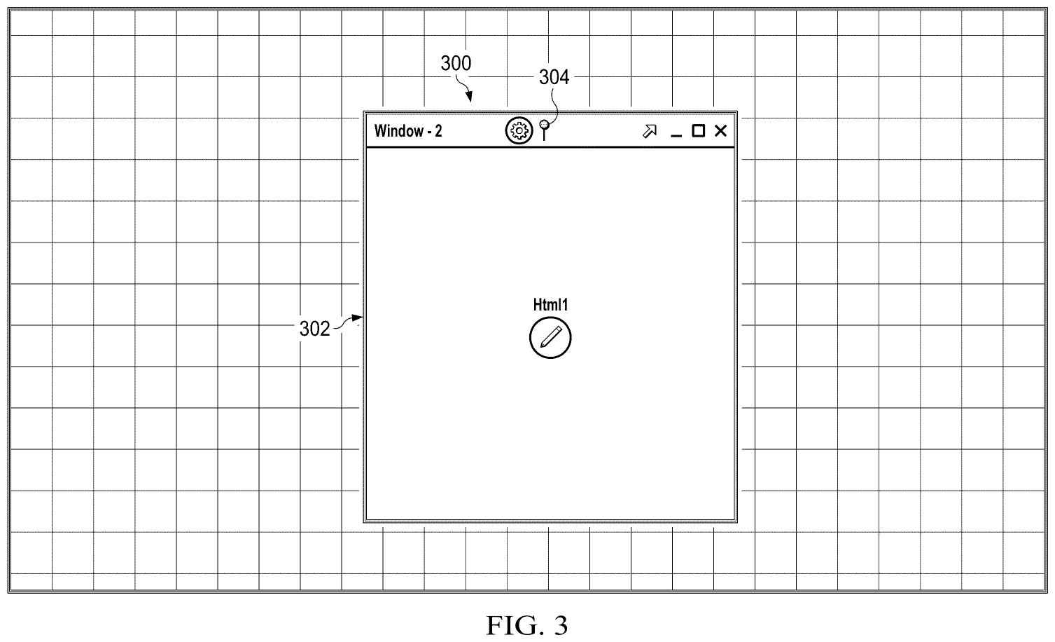

FIGS. 3 through 6 illustrate an example interface 300 for a drag-and-drop graphical user interface builder or other application supporting a mechanism for reducing inadvertent changes according to this disclosure. For case of explanation, the interface 300 is described as representing the interface for an application 112 executed by an application server 106 in the system 100 of FIG. 1, where the interface 300 of the graphical user interface builder is presented on a user device 102a-102d in the system 100 of FIG. 1. However, the graphical user interface builder or other application may be used with any other suitable device(s) and in any other suitable system(s), and the application may have any other suitable interface.

As shown in FIG. 3, the graphical user interface builder or other application is associated with an application interface 300 (such as its own graphical user interface). The application interface 300 allows a user to graphically create and modify graphical user interfaces and to define and modify individual GUI components within the graphical user interfaces. In this example, the application interface 300 is being used by a user to define a GUI component 302, such as an element to be presented within a larger graphical user interface. The GUI component 302 here includes or represents a hypertext markup language (HTML) component that is being defined or modified by the user.

When a change is made to the GUI component 302, a selectable change indicator element 304 is displayed in the application interface 300, such as in association with the GUI component 302. The selectable change indicator element 304 acts as an indicator to identify that a change has been made to the GUI component 302, where that change has not yet been accepted by the user. Note that any suitable change to the GUI component 302 may invoke presentation of the selectable change indicator element 304. For example, the selectable change indicator element 304 may be displayed when the GUI component 302 is moved within a graphical user interface or when one or more other properties of the GUI component 302 are modified (relative to a prior state of the GUI component 302).

Selection of the selectable change indicator element 304 by the user can trigger execution of one or more functions, such as applying the change(s) to the GUI component 302 (like by updating the application interface 300 to show the change(s)), saving the change(s) (like by updating the saved metadata 114), or both. In some cases, the selectable change indicator element 304 may be associated with a function handler that triggers or performs the application and/or saving of the change(s) to the GUI component 302. The selectable change indicator element 304 in this example takes the form of a pin, where selection of the selectable change indicator element 304 can be said to “pin” or make permanent the change(s) to the GUI component 302. Note, however, that the selectable change indicator element 304 may take any suitable form, such as a button or other icon that can be selected by the user.

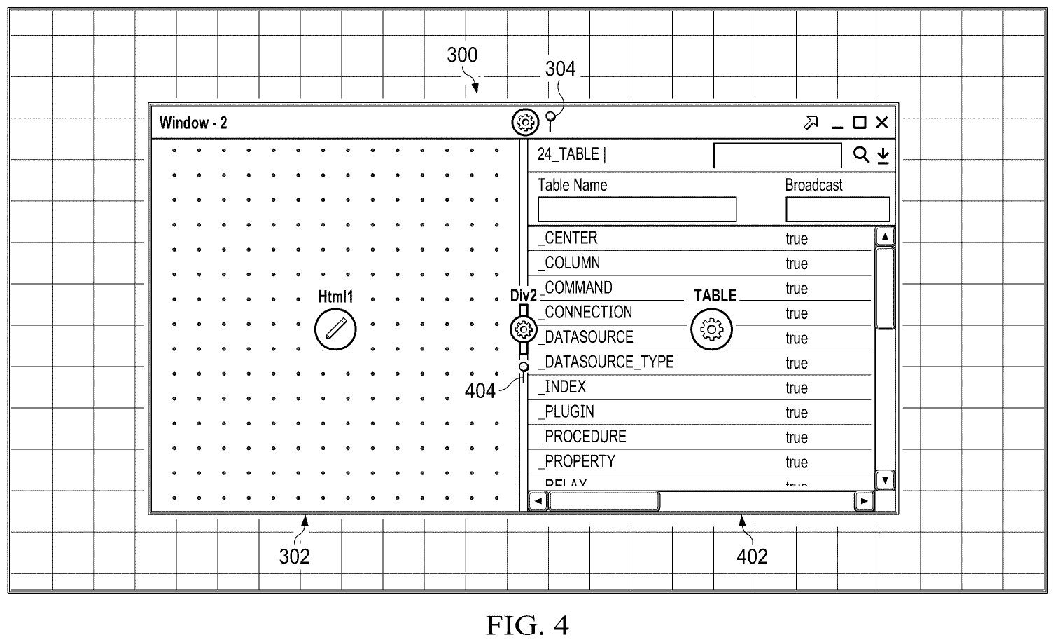

In some cases, the user may select the GUI component 302 or otherwise cause a table 402 of properties to be presented in the interface 300 as shown in FIG. 4. The table 402 contains various properties of the GUI component 302 that may be selected or otherwise controlled by the user. If the user makes one or more changes to the properties of the GUI component 302 in the table 402, a selectable change indicator element 404 may be displayed, such as in association with the table 402 of the GUI component 302. Again, the selectable change indicator element 404 acts as an indicator to identify that a change has been made to the GUI component 302, where that change has not yet been accepted by the user. Selection of the selectable change indicator element 404 by the user can trigger execution of one or more functions, such as by using a function handler, which can apply the change(s) to the GUI component 302, save the change(s), or both. Again, the selectable change indicator element 404 in this example takes the form of a pin, although the selectable change indicator element 404 may take any suitable form. As a result, it is possible for a GUI component with a selectable change indicator element 304 to include other elements (such as other GUI components) that also have their own selectable change indicator elements 404. As a particular example, nested GUI components can each have their own selectable change indicator elements.

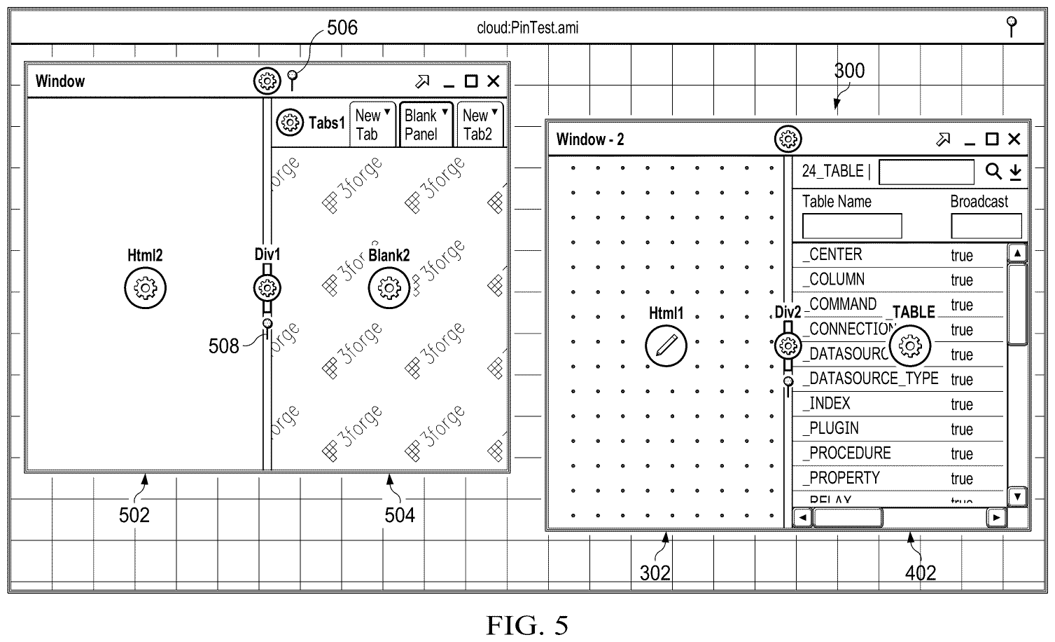

While FIGS. 3 and 4 illustrate a single GUI component 302 in the application interface 300, the application interface 300 may present multiple GUI components, an example of which is shown in FIG. 5. As shown in FIG. 5, the GUI component 302 is displayed next to another GUI component 502, which is associated with a set of properties 504 (in this case, various tabs). As can be seen here, it is possible for the other GUI component 502 to include one or more selectable change indicator elements 506 and 508, which can identify when changes are made to that GUI component 502 or to the properties of that GUI component 502. Selecting one or more of the selectable change indicator elements 506 and 508 can trigger execution of one or more functions, such as by one or more associated function handlers, to apply and/or save the updated metadata associated with the change(s).

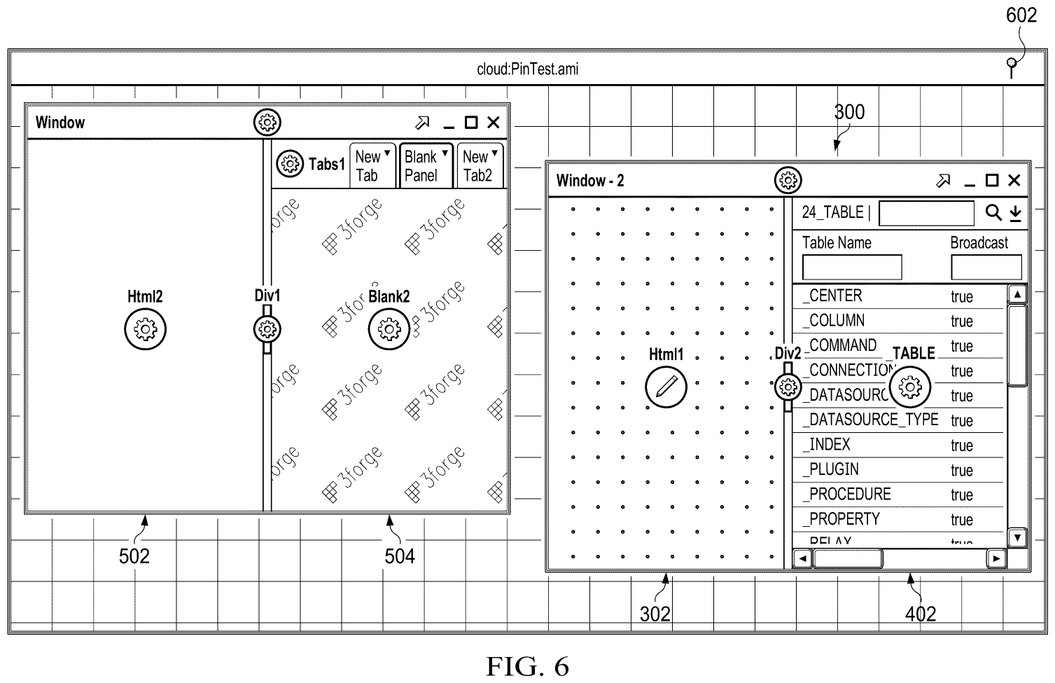

In addition, it is possible for the same selectable change indicator element to be used with multiple GUI components, an example of which is shown in FIG. 6. As shown in FIG. 6, both GUI components 302 and 502 are associated with a selectable change indicator element 602, which in this example is displayed in the application interface 300 but not directly in association with either of the GUI components 302 and 502. The selectable change indicator element 602 can be used to control whether one or more changes made to the GUI components 302 and 502 (such as their z-index values) are applied/saved or rejected. Selecting the selectable change indicator element 602 can trigger execution of one or more functions, such as by an associated function handler, to apply and/or save the updated metadata associated with the change(s).

Note that the positions of the selectable change indicator elements in FIGS. 3 through 6 are examples only. While the selectable change indicator elements are shown here as being located in specific positions (such as on the GUI component or graphical user interface that is modified), each selectable change indicator element may have any other suitable location (including on other GUI components presented in the application interface 300 or within the application interface 300 itself). Also note that the function handler associated with each selectable change indicator element may perform any suitable action(s) in order to apply or save metadata or otherwise to apply or save changes to graphical user interfaces or their GUI components. For instance, a function handler may contain logic that directly applies metadata to a GUI dashboard or other display, or the function handler may contain logic that indirectly applies metadata to a GUI dashboard or other display (such as through a transformation of the metadata to its eventual final value).

Although FIGS. 3 through 6 illustrate one example of an interface 300 for a drag-and-drop graphical user interface builder or other application supporting a mechanism for reducing inadvertent changes, various changes may be made to FIGS. 3 through 6. For example, while FIGS. 3 through 6 have illustrated various selectable change indicator elements taking the form of pins that can be clicked or otherwise selected, this is for illustration and explanation only. Each selectable change indicator element may have any other suitable form and operation. For instance, each selectable change indicator element may vary in shape or size. Also, each selectable change indicator element may include or be associated with an image that provides a visual representation of its functionality. Further, each selectable change indicator element may be associated with multiple function handlers or a menu that allows for multiple functions to be invoked, which could provide improved control over a GUI component. Moreover, each selectable change indicator element may contain or be used to invoke non-metadata-related or other non-change-related functionality in order to provide additional functionality to a user. In addition, each selectable change indicator element may be triggered in different ways to provide various controllable actions, such as when each selectable change indicator element can be clicked, double-clicked, or right-clicked to invoke different actions. Finally, note that the specific uses of the selectable change indicator elements shown in FIGS. 3 through 6 are merely examples of how selectable change indicator elements could be used, and the selectable change indicator elements may be used in any other suitable manner to accept or reject any other suitable changes to graphical user interfaces.

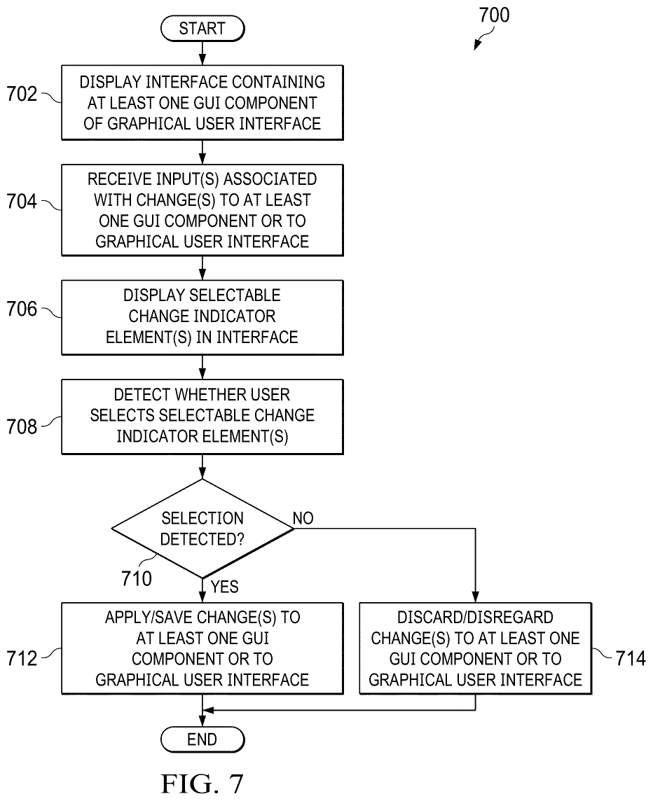

FIG. 7 illustrates an example method 700 for reducing inadvertent changes in a drag-and-drop graphical user interface builder or other application according to this disclosure. For case of explanation, the method 700 is described as being performed by an application server 106 in the system 100 of FIG. 1, where the application server 106 includes one or more instances of the device 200 of FIG. 2 and supports the interface 300 of FIGS. 3 through 6. However, the method 700 may be performed using any other suitable device(s) and in any other suitable system(s), and the method 700 may involve the use of any other suitable interface(s).

As shown in FIG. 7, an interface containing at least one GUI component of a graphical user interface is displayed at step 702. This could include, for example, the processing device 202 of the application server 106 initiating presentation of the interface 300 on an end user device 102a-102d. The interface 300 can allow one or more users to define, modify, and otherwise configure one or more GUI components 302, 502 of a graphical user interface and to define, modify, and otherwise configure the overall graphical user interface itself.

One or more inputs associated with one or more changes to the at least one GUI component or to the graphical user interface are received at step 704. This could include, for example, the processing device 202 of the application server 106 determining that the one or more users have provide input(s) changing the one or more GUI components 302, 502 or the associated graphical user interface. As particular examples, this could include the processing device 202 of the application server 106 determining that the one or more users have moved the GUI component(s) 302, 502 within the graphical user interface or modified one or more other properties of the GUI component(s) 302, 502 (such as within one or more tables 402 or one or more sets of properties 504).

At least one selectable change indicator element is displayed in the interface at step 706. This could include, for example, the processing device 202 of the application server 106 initiating presentation of one or more selectable change indicator elements 304, 404, 506, 508, 602 within or associated with the interface 300. Each selectable change indicator element 304, 404, 506, 508, 602 indicates that at least one corresponding change has been made to the at least one GUI component 302, 502 or to the graphical user interface. Depending on the change(s) made, there may be a single selectable change indicator element associated with each of one or more GUI components, multiple selectable change indicator elements associated with each of one or more GUI components, and/or a selectable change indicator element associated with the overall graphical user interface.

A determination is made whether any selectable change indicator element or elements have been selected at step 708. This could include, for example, the processing device 202 of the application server 106 determining whether at least one of the one or more users has clicked on or otherwise selected any of the one or more selectable change indicator elements 304, 404, 506, 508, 602 presented in the interface 300.

If a selection of at least one selectable change indicator element is detected at step 710, the associated change or changes to the at least one GUI component or to the graphical user interface are applied or saved in response to the selection of the selectable change indicator element(s) at step 712. This could include, for example, the processing device 202 of the application server 106 applying or saving updated metadata associated with the change(s) to the GUI component(s) 302, 502 or to the graphical user interface. In some embodiments, this can be performed using a function handler associated with each selected selectable change indicator element. Also, in some embodiments, a change to the GUI component(s) 302, 502 or to the graphical user interface may be applied or saved only in response to the selection of the associated selectable change indicator element. Note that the change or changes that are applied or saved here can depend on which selectable change indicator element or elements 304, 404, 506, 508, 602 are selected. For instance, selecting each of the selectable change indicator elements 304, 404, 506, 508 may apply or save one or more changes involving an individual GUI component 302, 502, while selecting the selectable change indicator element 602 may apply or save one or more changes involving any individual GUI components 302, 502.

If a selection of a selectable change indicator element is not detected at step 710, any associated change(s) with one or more unselected selectable change indicator elements can be discarded or disregarded at step 714. This could include, for example, the processing device 202 of the application server 106 ignoring any changes to the GUI component(s) 302, 502 or to the overall graphical user interface that were not accepted by the one or more users via selection of the corresponding selectable change indicator element(s). Depending on the implementation, a user may be given the option of actively rolling back each unaccepted change to restore a GUI component or graphical user interface to a previous state. A user may also be given a warning if the user attempts to close a graphical user interface builder or other application when there is at least one unaccepted change.

Although FIG. 7 illustrates one example of a method 700 for reducing inadvertent changes in a drag-and-drop graphical user interface builder or other application, various changes may be made to FIG. 7. For example, while shown as a series of steps, various steps in FIG. 7 could overlap, occur in parallel, occur in a different order, or occur any number of times (including zero times). As a particular example, there could be any number of changes made to GUI components 302, 502 and/or to an overall graphical user interface, and there may be any number of possible sequences that involve making the various changes and accepting/rejecting the various changes. As another particular example, when there are multiple selectable change indicator elements presented to a user, steps 708-710 and one of steps 712-714 can be performed for each selectable change indicator element.

It should be noted that the functions shown in the figures or described above can be implemented in an end user device 102a-102d, application server 106, or other device(s) in any suitable manner. For example, in some embodiments, at least some of the functions shown in the figures or described above can be implemented or supported using one or more software applications or other software instructions that are executed by at least one processor of the end user device 102a-102d, application server 106, or other device(s). In other embodiments, at least some of the functions shown in the figures or described above can be implemented or supported using dedicated hardware components. In general, the functions shown in the figures or described above can be performed using any suitable hardware or any suitable combination of hardware and software/firmware instructions. Also, the functions shown in the figures or described above can be performed by a single device or by multiple devices.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in this patent document should not be read as implying that any particular element, step, or function is an essential or critical element that must be included in the claim scope. Also, none of the claims is intended to invoke 35 U.S.C. § 112 (f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” “processing device,” or “controller” within a claim is understood and intended to refer to structures known to those skilled in the relevant art, as further modified or enhanced by the features of the claims themselves, and is not intended to invoke 35 U.S.C. § 112 (f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
displaying an interface containing at least one graphical user interface (GUI) component of a graphical user interface;
receiving input associated with a change to the at least one GUI component or to the graphical user interface;
displaying a selectable change indicator element in the interface, the selectable change indicator element indicating that the change to the at least one GUI component or to the graphical user interface has been made;
detecting a selection of the selectable change indicator element; and
applying or saving the change to the at least one GUI component or to the graphical user interface in response to the selection of the selectable change indicator element.

2. The method of claim 1, wherein the change to the at least one GUI component or to the graphical user interface is applied or saved only in response to the selection of the selectable change indicator element.

3. The method of claim 1, wherein:
the selectable change indicator element is associated with a function handler; and
the function handler applies or saves the change to the at least one GUI component or to the graphical user interface in response to the selection of the selectable change indicator element.

4. The method of claim 1, wherein:
each GUI component or the graphical user interface is associated with metadata; and
applying or saving the change to the at least one GUI component or to the graphical user interface comprises updating the metadata associated with the at least one GUI component or the graphical user interface.

5. The method of claim 1, wherein:
the interface is configured to present multiple GUI components of the graphical user interface; and
the selectable change indicator element comprises one of multiple selectable change indicator elements, different selectable change indicator elements associated with different GUI components.

6. The method of claim 1, wherein:
the interface is configured to present multiple GUI components of the graphical user interface, at least two of the multiple GUI components forming a nested GUI component; and
the selectable change indicator element comprises one of multiple selectable change indicator elements, at least two of the selectable change indicator elements associated with the at least two GUI components forming the nested GUI component.

7. The method of claim 1, wherein:
the interface is configured to present multiple GUI components of the graphical user interface; and
applying or saving the change to the at least one GUI component or to the graphical user interface comprises applying or saving multiple changes to the multiple GUI components in response to the selection of the selectable change indicator element.

8. An apparatus comprising:
at least one processing device configured to:
initiate display of an interface containing at least one graphical user interface (GUI) component of a graphical user interface;
receive input associated with a change to the at least one GUI component or to the graphical user interface;
initiate display of a selectable change indicator element in the interface, the selectable change indicator element indicating that the change to the at least one GUI component or to the graphical user interface has been made;
detect a selection of the selectable change indicator element; and
apply or save the change to the at least one GUI component or to the graphical user interface in response to the selection of the selectable change indicator element.

9. The apparatus of claim 8, wherein the at least one processing device is configured to apply or save the change to the at least one GUI component or to the graphical user interface only in response to the selection of the selectable change indicator element.

10. The apparatus of claim 8, wherein:
the selectable change indicator element is associated with a function handler; and
the function handler is configured to apply or save the change to the at least one GUI component or to the graphical user interface in response to the selection of the selectable change indicator element.

11. The apparatus of claim 8, wherein:
each GUI component or the graphical user interface is associated with metadata; and
to apply or save the change to the at least one GUI component or to the graphical user interface, the at least one processing device is configured to update the metadata associated with the at least one GUI component or the graphical user interface.

12. The apparatus of claim 8, wherein:
the interface is configured to present multiple GUI components of the graphical user interface; and
the selectable change indicator element comprises one of multiple selectable change indicator elements, different selectable change indicator elements associated with different GUI components.

13. The apparatus of claim 8, wherein:
the interface is configured to present multiple GUI components of the graphical user interface, at least two of the multiple GUI components forming a nested GUI component; and
the selectable change indicator element comprises one of multiple selectable change indicator elements, at least two of the selectable change indicator elements associated with the at least two GUI components forming the nested GUI component.

14. The apparatus of claim 8, wherein:
the interface is configured to present multiple GUI components of the graphical user interface; and
the at least one processing device is configured to apply or save multiple changes to the multiple GUI components in response to the selection of the selectable change indicator element.

15. A non-transitory machine readable medium containing instructions that when executed cause at least one processor to:
initiate display of an interface containing at least one graphical user interface (GUI) component of a graphical user interface;
receive input associated with a change to the at least one GUI component or to the graphical user interface;
initiate display of a selectable change indicator element in the interface, the selectable change indicator element indicating that the change to the at least one GUI component or to the graphical user interface has been made;
detect a selection of the selectable change indicator element; and
apply or save the change to the at least one GUI component or to the graphical user interface in response to the selection of the selectable change indicator element.

16. The non-transitory machine readable medium of claim 15, wherein the instructions when executed cause the at least one processor to apply or save the change to the at least one GUI component or to the graphical user interface only in response to the selection of the selectable change indicator element.

17. The non-transitory machine readable medium of claim 15, wherein:
each GUI component or the graphical user interface is associated with metadata; and
the instructions that when executed cause the at least one processor to apply or save the change to the at least one GUI component or to the graphical user interface comprise:
instructions that when executed cause the at least one processor to update the metadata associated with the at least one GUI component or the graphical user interface.

18. The non-transitory machine readable medium of claim 15, wherein:
the interface is configured to present multiple GUI components of the graphical user interface; and
the selectable change indicator element comprises one of multiple selectable change indicator elements, different selectable change indicator elements associated with different GUI components.

19. The non-transitory machine readable medium of claim 15, wherein:
the interface is configured to present multiple GUI components of the graphical user interface, at least two of the multiple GUI components forming a nested GUI component; and
the selectable change indicator element comprises one of multiple selectable change indicator elements, at least two of the selectable change indicator elements associated with the at least two GUI components forming the nested GUI component.

20. The non-transitory machine readable medium of claim 15, wherein:
the interface is configured to present multiple GUI components of the graphical user interface; and
the instructions that when executed cause the at least one processor to apply or save the change to the at least one GUI component comprise:
instructions that when executed cause the at least one processor to apply or save multiple changes to the multiple GUI components in response to the selection of the selectable change indicator element.
